(19) United States
(12) Patent Application Publication
(10) Pub. No.: US 2026/0220620 A1
(43) Pub. Date: Jul. 30, 2026

(54) Integrated Dining And Dating Application

(71) Applicant: Eric Snead, Upper Marlboro, MD (US)

(72) Inventor: Eric Snead, Upper Marlboro, MD (US)

(21) Appl. No.: 19/039,696

(22) Filed: Jan. 28, 2025

(51) Int. Cl. G06Q 50/00; G06Q 10/02; G06Q 30/018; G06Q 50/12

(52) U.S. Cl. CPC G06Q 10/40; G06Q 10/02; G06Q 50/12; G06Q 30/018

(57) ABSTRACT

Applications are provided for computing devices, such as mobile phones, that enhance the dating experience by integrating personalized dining options with a suite of innovative features. The applications enable users to customize their meals, drinks, and desserts according to their preferences, facilitating a personalized and seamless dining experience. Key features include a Date Scheduler for finding and booking reservations, Join My Table for facilitating spontaneous connections, and Surprise Connections for randomly selecting dining locations and matches based on user preferences. The applications can also include Meal Gifter and Thankful Tidbit features, which allow users to pre-pay for meals and include gratuity. Emphasizing safety and trust, the applications can integrate profile verification, allergy alerts, and comprehensive feedback systems. The disclosed applications may utilize AI-enhanced processes for improving user matching, dining selections, and personalized experiences, ensuring a streamlined and secure user experience.

### FIELD OF THE INVENTION

The invention relates to a dining and dating application with integrated features.

### BACKGROUND OF THE INVENTION

Dating applications have been used in the past but they suffer from a failure to seamlessly integrate features that make the dating and associated dining experience better for the users. These previous applications can also lack convenience and efficiency, inure payment awkwardness, lack personalization, lack safety and trust, lack spontaneity and adventure, lack generosity and recognition, and/or lack constructive feedback to users. Certain of the problems and the complications caused by them can be described as follows:
1. Lack of Integration Between Dating and Dining:
   Problem: Existing dating apps do not seamlessly integrate with dining experiences, requiring users to coordinate dining details separately.
   Complication: This separation adds complexity and inconvenience to planning dates, as users must switch between multiple apps or platforms to finalize their dining plans.
2. Payment Awkwardness:
   Problem: Traditional dating apps do not address the awkwardness associated with deciding who pays for the meal during a date.
   Complication: This can lead to uncomfortable situations, potentially affecting the overall dating experience and user satisfaction.
3. Limited Personalization:
   Problem: Many dining apps and some dating apps offer limited options for personalizing the dining experience based on individual preferences and dietary restrictions.
   Complication: Users may find it challenging to find suitable dining options that cater to their specific tastes and needs, leading to less enjoyable experiences.
4. Safety and Trust Concerns:
   Problem: Profile authenticity and user safety are significant concerns in the dating app industry, with many apps lacking robust verification processes.
   Complication: Users may be hesitant to trust the profiles they encounter, leading to reduced engagement and potential security risks.
5. Feedback and Accountability:
   Problem: Existing apps often lack a comprehensive feedback system that allows users to provide and receive constructive feedback on their dates.
   Complication: Without a mechanism for accountability, users may have negative experiences that go unaddressed, diminishing the app's overall reputation and effectiveness.
6. Inadequate Allergy and Dietary Management:
   Problem: Few dating or dining apps offer features to manage allergies and dietary restrictions effectively.
   Complication: This oversight can lead to unsafe dining situations, reducing the app's appeal to users with specific dietary needs.
7. Spontaneity and Adventure:
   Problem: Traditional dating apps do not facilitate spontaneous connections and adventures, which can make the dating process feel routine and predictable.
   Complication: Users looking for excitement and unique experiences may find existing solutions lacking in features that encourage spontaneity and discovery.
8. Generosity and Gratitude:
   Problem: Current apps do not have integrated features to promote generosity, such as paying for a date's meal or tipping restaurant staff.
   Complication: This can lead to missed opportunities for fostering positive interactions and goodwill among users and service providers.

Addressing these issues with a comprehensive, integrated solution can significantly enhance the user experience and overall effectiveness of the platform. A need therefore exists for a dining and dating application that has integrated features the users need for better experiences.

### SUMMARY OF THE INVENTION

This invention provides innovative applications and methods for applying such that integrate dating and dining, providing users with a seamless platform to plan dates, select restaurants, and pre-pay for meals. The applications and methods offer a personalized and user-friendly interface, allowing users to customize their dining experiences, choose preferred cuisines, and make reservations effortlessly. The applications and methods are preferably used on a computing device, such as a mobile telephone, which is most preferred, a tablet, laptop, or desktop computer.

A questionnaire (implemented with a questionnaire module that facilitates the asking of questions to a user and the user's responses) and integrated features relating to dining and dating are integrated into the applications by the use of different or combined modules in these preferred embodiments. The questionnaire is used to set up a user profile containing information such as preferences in dining, food, and other activities, preferences in dating, schedule information for the user, and other personal information.

These integrated features provided in light of the user's profile include: 1. Personalized Dining: Users can tailor their meals, drinks, and desserts according to their preferences, adding a unique touch to their dates, using a Personalized Dining Module; 2. Date Scheduler: Facilitates the planning process by helping users find available reservations that align with their selected time and date using a Date Scheduler Module; 3. Join My Table: Encourages spontaneous connections by allowing users to join or invite others to pre-planned dates at selected restaurants using a Join My Table Module; 4. Surprise Connections: Adds an element of excitement by randomly selecting dining locations and matches based on user preferences using a Surprise Connections Module; 5. Meal Gifter: Promotes generosity by allowing users to pay for their date's meal using a Meal Gifter Module; 6. Thankful Tidbit: Allows users to include gratuity when pre-paying for meals, ensuring restaurant staff are appropriately recognized using a Thankful Tidbit Module; 7. Diners Rating and Feedback: Users can provide feedback and rate their dates, promoting accountability and informed decision-making using a Diners Rating and Feedback Module; 8. Allergy Alert: Ensures safe dining experiences by allowing users to specify allergies in their profiles using an Allergy Alert Module; and 9. Verified Profiles: Enhances trust and safety with profile verification options using a Verified Profile Module.

Additional integrated features implemented in the application in separate or combined modules can include: 10. Pre-Order Flowers and Candy: Users can pre-order flowers and candy for their dates; 11. Hair and Beauty Services: Options for users to pre-book haircuts, hair styling, and other beauty services; 12. Car Wash Services: Users can pre-order car wash services; 13. Coffee or Tea Dates: Users can set up casual coffee or tea dates; 14. Profile Matching Algorithm: Detailed algorithm for matching users; 15. Dynamic Pricing and Offers:
Implement dynamic pricing, discounts, and special offers; 16. Event Integration: Integration with local events or themed (e.g., dining) experiences; 17. Virtual Dining Options: Options for virtual dining experiences; 18. Subscription Tiers and Loyalty Programs: Various subscription levels and loyalty rewards; 19. AI Recommendations: AI-driven recommendations for restaurants, dates, and activities; 20. Integrated Payment System: Secure payment gateway integration; 21. Safety Features: Advanced safety features like real-time location sharing, emergency alert buttons, and post-date check-ins; 22. In-App Messaging and Video Calls: Secure and private in-app messaging and video calling features; 23. App Feedback and Reporting System: Comprehensive system for reporting inappropriate behavior, bugs, and providing feedback on user experiences; and 24. Cross-User Rating and Feedback: Users can provide feedback and rate their dates based on their experience and these ratings and feedback will be visible to other users, with benefits that include promoting transparency, accountability, and informed decision-making by allowing users to see the ratings and feedback of potential dates. This feature helps ensure that users engage in respectful and considerate behavior, enhancing the overall quality of the community.

The problems solved and advantageous of embodiments of this invention are multifold and include:
Convenience and Efficiency: embodiments of this invention streamline the dating process, making it easy for users to plan and manage their dates without the hassle of coordinating multiple aspects separately.
Eliminates Payment Awkwardness: By pre-paying for meals, embodiments of this invention remove the awkwardness and potential disputes over who pays, creating a smoother and more enjoyable dining experience.
Personalization: Users can customize their dining preferences, ensuring each date is tailored to their tastes and dietary needs, enhancing the overall experience.
Safety and Trust: With features like Allergy Alert and Verified Profiles, embodiments of this invention prioritize user safety and fosters a trustworthy environment.
Spontaneity and Adventure: Features like Join My Table and Surprise Connections introduce spontaneity and excitement into the dating experience, making each interaction unique and memorable.
Generosity and Recognition: Meal Gifter and Thankful Tidbit promote generosity and ensure that restaurant staff are appreciated, contributing to a positive dining atmosphere.
Constructive Feedback: The rating and feedback system helps users provide and receive constructive feedback, fostering a respectful and growth-oriented community.

A particularly preferred embodiment of this invention includes the following:

An application and method for facilitating dining and dating for a user using a mobile telephone is provided. This application and method comprise: access to store and retrieve memory on a storage medium; a questionnaire module that presents questions to a user on an interface concerning the user's schedule, preferences, and personal information and that stores the user's schedule, preferences, and personal information on the storage medium in a user's profile; and a first set of a plurality of separate or combined modules that integrate dining at a restaurant, dating on a date, and the user's profile.

The first set of modules that can be used in this application and method comprise: a personalized dining module that matches the user's profile to meals, drinks, and deserts at the restaurant; a date scheduler module that identifies available reservations at the restaurant with the user's profile; a join my table module that identifies other users to join the user at the restaurant; a surprise connection module that randomly selects restaurants based on the user's profile; a meal gifter module that allows the user to pay for the meal of another user; a thankful tidbit module that allows the user to pre-pay for meals at the restaurant; a diners rating and feedback module that allows the user to provide feedback concerning the restaurant, another user, and a date; an allergy alert module that identifies an allergy risk to a user based on the user's profile; and a verification module that verifies the user's profile information.

A second set of modules that can be used in this application and method comprises: a pre-order flowers/candy module that pre-orders flowers and candy for the date; a hair and beauty services module that pre-books hair and beauty services for the date; a car wash services module that pre-orders car wash services for the date; a coffee or tea date module that sets up casual coffee or tea dates; a profile matching algorithm module that matches the user to other users; a dynamic pricing and offer module that identifies dynamic pricing, discounts, and special offers from the restaurant or for the date; an event integration module that identifies local events or themed experiences for a date; a virtual dining module that provides a selection to choose virtual dining; subscription tiers and loyalty program module that allows the user to select which modules to apply; an AI module that uses AI-driven recommendations for the restaurant and the date using an AI trained on the user's profile and other users' profiles and the diners rating and feedback module; an integrated payment module that secures payments for the restaurant and date; a safety module that allows for location sharing, emergency alert buttons, and post-date check-ins; an in-app messaging and video calls module that secures private in-app messaging and video calling between the user and other users; an app feedback and reporting module that allows the reporting of inappropriate behavior of users on dates, app bugs, and app feedback; and a cross-user rating and feedback module that allows access to the user's and other users' feedback concerning the restaurant, another user, and a date from the diners rating and feedback module.

In addition to the above, the AI training process and data security features anonymize and protect user data. They do this by applying one or more of the following:
A. Data Anonymization and Aggregation: All user data used in the AI training process is stripped of identifiable information, with details like names and contact information masked or removed. Data is also pooled and analyzed in groups rather than individually, helping the AI learn from general patterns and enhancing security.
B. Secure Data Handling During Training: Only authorized personnel and AI processes can access training data, which is stored on secure servers or cloud environments. Any data in transit or at rest is encrypted to prevent unauthorized access.
C. Regular Audits and Compliance: Regular security audits ensure data handling aligns with privacy laws. All data processing complies with GDPR, CCPA, and other relevant data protection standards, respecting user privacy throughout the AI training process.

In the most preferred embodiments, this invention complies with all privacy laws and regulations that apply or that could apply. This includes GDPR and CCPA, as well as additional possible laws and regulations. This is an important feature of these embodiments, given the data-driven nature of the invention (e.g., with AI and verification modules).

The modules, methods and features they implement as described herein can be combined into a single module, or groups of modules, or maintained as separate modules. In some embodiments, different sets of these modules are used as compared to other embodiments. In other embodiments, the user can select which modules the user is going to use and which will not be used.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is schematic of a wireframe showing several screen shots of mobile devices presenting features of embodiments of this invention.

FIG. 2 is a schematic showing a Dashboard feature implementation of an embodiment of this invention.

FIG. 3 is a schematic showing a My Bookings feature implementation of an embodiment of this invention.

FIG. 4 is a schematic showing a Menu Items feature implementation of an embodiment of this invention.

FIG. 5 is a schematic showing a Tables feature implementation of an embodiment of this invention.

FIG. 6 is a schematic showing a Transactions feature implementation of an embodiment of this invention.

FIG. 7 is a schematic showing a Settings feature implementation of an embodiment of this invention.

FIG. 8 is a flowchart showing an embodiment of artificial intelligence enhanced processes of this invention.

FIG. 9 is a flowchart showing an embodiment of user profile verification processes of this invention.

FIG. 10 is a flowchart showing an embodiment of restaurant and date matching processes of this invention.

FIG. 11 is a flowchart showing an embodiment of payment and pre-payment processes of this invention.

FIG. 12 is a flowchart showing an embodiment of safety module processes of this invention.

FIG. 13 is an example of a first page of an application embodiment of this invention.

FIG. 14 is an example of a second page of an application embodiment of this invention.

FIG. 15 is an example of a third page of an application embodiment of this invention.

FIG. 16 is an example of a fourth page of an application embodiment of this invention.

FIG. 17 is an example of a fifth page of an application embodiment of this invention.

FIG. 18 is an example of a sixth page of an application embodiment of this invention.

### DETAILED DESCRIPTION OF THE INVENTION

The embodiments of this invention solve the problems with traditional approaches in the field of dating and dining. Several of these traditional approaches and drawbacks from them that embodiments of this invention can address can be described as follows:
1. Separate Platforms for Dating and Dining:
   Approach: Traditionally, dating and dining have been handled separately. Individuals used dating apps or websites to find potential matches and then used dining apps or websites, such as Yelp or OpenTable, to make dining reservations.
   Drawback: This separation required users to juggle multiple platforms, complicating the coordination of dates and often leading to fragmented and inefficient planning.
2. Manual Coordination of Date Details:
   Approach: Users had to manually coordinate details such as date, time, and location through messaging within the dating app or through external communication methods like phone calls and text messages.
   Drawback: This manual process was time-consuming and prone to miscommunication, making the dating experience more stressful and less enjoyable.
3. On-the-Spot Payment Decisions:
   Approach: Traditionally, the decision of who pays for the meal was made at the restaurant, often leading to awkward moments and potential disagreements during the date.
   Drawback: This lack of pre-planned payment solutions added an unnecessary layer of discomfort and could detract from the overall dating experience.
4. Limited Personalization:
   Approach: While some restaurants allowed for menu customization, the ability to personalize dining experiences through apps was limited. Users had to communicate their preferences and dietary restrictions directly with the restaurant staff.
   Drawback: This limited personalization could result in unsatisfactory dining experiences, especially for individuals with specific dietary needs or preferences.
5. Lack of Integrated Safety Features:
   Approach: Safety and trust were primarily managed through user discretion and basic profile information provided by dating apps. Some apps offered optional background checks, but these were not universally adopted.
   Drawback: This led to concerns about the authenticity of profiles and the safety of meeting strangers, reducing user confidence and engagement.
6. Minimal Feedback Mechanisms:
   Approach: Traditional dating apps often provided limited or no mechanisms for users to give and receive feedback about their dates. Dining apps focused on restaurant reviews rather than feedback on individual dining experiences related to dates.
   Drawback: Without a structured feedback system, users lacked a way to share their experiences constructively, missing opportunities for personal growth and accountability.
7. Lack of Spontaneity and Adventure:
   Approach: Dating and dining were often pre-planned with little room for spontaneous decisions. Users typically chose familiar or highly recommended restaurants to ensure a positive experience.
   Drawback: This cautious approach limited the sense of adventure and discovery, which could make the dating process feel routine and less exciting.
8. No Integrated Generosity Features:
   Approach: Acts of generosity, such as paying for a date's meal or tipping, were managed individually and spontaneously without integrated app features to facilitate these actions.
   Drawback: This ad-hoc approach missed opportunities to enhance the dating experience through thoughtful gestures, and there was no structured way to ensure restaurant staff received appropriate recognition.

Traditionally, dating and dining were managed through separate platforms and manual coordination, leading to inefficiencies, the inability to include a broad spectrum of information available to AI and automated processes, and potential miscommunications. Payment decisions were made on the spot, causing awkwardness, while limited personalization and safety features reduced the overall user experience. The lack of integrated feedback systems, spontaneous features, and mechanisms to promote generosity further detracted from the potential richness of dating experiences. Addressing these traditional shortcomings can significantly enhance the dating and dining process, making it more seamless, enjoyable, and secure.

The preferred embodiments of this invention are designed to enhance the dating experience by integrating personalized dining options and a suite of unique features. The applications and methods allow users to tailor their meals, drinks, and desserts according to their preferences, facilitating personalized dining experiences. Key features include a Date Scheduler that helps users find and book reservations, the Join My Table feature for spontaneous connections, and Surprise Connections which randomly select dining locations and matches based on user preferences.

These preferred embodiments promote generosity and convenience through their Meal Gifter and Thankful Tidbit features, enabling users to pre-pay for meals and include gratuity. The applications and methods emphasize user safety and trust with verified profiles, allergy alerts, and comprehensive feedback systems. Users can provide ratings and feedback, visible to others, promoting accountability and informed decision-making.

Additional features include pre-ordering flowers, candy, and car wash services, as well as booking beauty and grooming appointments, ensuring users are well-prepared for their dates. These embodiments support casual coffee or tea dates and offer virtual dining options, enhancing flexibility and inclusivity. These applications leverage AI-driven recommendations for personalized suggestions, dynamic pricing, event integration, and secure in-app messaging and video calls. Advanced safety features include real-time location sharing, emergency alerts, and post-date check-ins.

Important types of features, preferably implemented in one or more modules, of certain of the embodiments of this invention can include:
1. Integrated Dating and Dining Platform: Embodiments of this invention seamlessly integrate dating and dining into a single platform, allowing users to plan dates, select restaurants, and make reservations without leaving the app. Unlike traditional approaches where dating and dining are handled separately, this integrated solution simplifies the entire process, offering a more cohesive and user-friendly experience.
2. Pre-Payment and Awkwardness-Free Dining: Embodiments of this invention allow users to pre-pay for meals, using a Pre-Payment Module, eliminating the awkwardness of deciding who pays during the date. This feature addresses a common pain point in dating, making the experience more comfortable and stress-free for users.
3. Personalized Dining Experiences: Embodiments of this invention allow users to customize their meals, drinks, and desserts through their profiles, using a Profile Module, ensuring that each dining experience reflects their tastes and dietary needs. This high level of personalization is unique, allowing users to enjoy tailored dining experiences that enhance the overall quality of their dates.
4. Date Scheduler and Join My Table Features: Embodiments of this invention allow a Date Scheduler Module to help users find available reservations that align with their selected time and date, while the Join My Table feature, provided by a Join My Table Module, allows users to join or invite others to pre-planned dates. These features streamline the planning process and encourage spontaneous connections, adding a dynamic and social aspect to dating.
5. Surprise Connections: Embodiments of this invention offer a random eating location feature, through a Surprise Connection Module, allowing users to explore new dining experiences based on their geographical area after finding a match. This element of surprise and spontaneity adds excitement to the dating process, making each date unique and memorable.
6. Meal Gifter and Thankful Tidbit Features: Embodiments of this invention provide for a Meal Gifter feature, through a Meal Gifter Module, that lets users pay for their date's meal, while the Thankful Tidbit feature, through a Thankful Tidbit Module, allows users to include gratuity when pre-paying for meals. These features promote generosity and ensure that restaurant staff are appropriately recognized, enhancing the overall dining and dating experience.
7. Diners Rating and Constructive Feedback: Embodiments of this invention allow users to rate their dates and provide feedback on their experiences, promoting accountability and helping others make informed decisions, using a Diners Rating and Constructive Feedback Module. The comprehensive feedback system includes star ratings, detailed categories, and a comment section, fostering a respectful and growth-oriented community.
8. Allergy Alert: Embodiments of this invention allow users to specify their allergies in their profiles, ensuring safe and enjoyable dining experiences, using an Allergy Alert Module. This feature prioritizes user safety and addresses dietary restrictions, making dining out more inclusive and secure.
9. Verified Profiles: Embodiments of this invention allow profile verification options to enhance trust and safety among users using the Profile Module. The emphasis on verified profiles builds user confidence and promotes a trustworthy dating environment.

A profile verification module in some embodiments can utilize a multi-step process to ensure the authenticity and accuracy of user information. Upon registration, the user submits personal information such as their name, email address, and a government-issued ID. This information is cross-verified with third-party databases for identity verification. Additionally, users can opt for further verification through social media account integration or manual verification by a supervising team.

AI in some embodiments is also applied to detect inconsistencies in profile data by cross-referencing user activity patterns with known verification markers, such as geolocation, behavioral signals, and reported information from other users. Verified users are awarded a verification badge, and the module runs periodic checks to ensure profile integrity is maintained over time.

As stated above, the AI training process and use of data herein is preferably anonymized and protected, complying with privacy laws and regulations, and using one or more of data anonymization and aggregation modules, selected personnel and encryption of data for AI processes, and/or regular audits and checking of compliance.

In certain preferred embodiments the profile verification process includes a periodic check. This comprises, some or all of the following: a. Re-Verification: Periodically (i.e., set interval) prompting users to re-verify key details, such as identity verification or updated profile photos, or re-verifying triggered by an event (e.g., feedback). b. Activity Monitoring: Monitoring behavior patterns to detect unusual activity, which helps identify inactive accounts or potential misuse of the platform. c. Cross-Referencing with Third-Party Databases: Regularly re-checking user information with third-party databases to ensure consistency. d. User Feedback Integration: Gathering user feedback about interactions with verified profiles to identify cases where re-verification might be necessary. e. Social Media Integration Checks: For users who link social media accounts, confirming periodically that linked profiles remain active and consistent.
10. Icebreaker Questions: Embodiments of this invention provide for, users, after confirming a date, to receive icebreaker questions if desired based on their profiles to spark interesting and meaningful conversations, using the Icebreaker Question Module. This feature helps reduce initial awkwardness and encourages engaging interactions, making dates more enjoyable.
11. Artificial Intelligence: Certain embodiments of this invention may use artificial intelligence (AI) to enhance module operation and the applications' abilities. For example, AI, implemented in an AI module, in some embodiments can use user profiles and diner feedback to provide personalized recommendations for matches and restaurants

An AI module can be trained using a diverse dataset comprising user preferences, historical interactions, and feedback from past dining experiences. The training process involves analyzing data points such as dining preferences (cuisine type, location, budget), user compatibility metrics (schedule alignment, shared interests), and feedback on previous matches. AI-based matching and restaurant suggestions are generated in real-time by continuously refining the model as new user data and feedback are collected. The model learns from successful outcomes (e.g., positive feedback and repeat engagements) and uses this data to improve future recommendations.

In certain embodiments, the AI can apply a multi-layered recommendation algorithm that first filters dining options based on the user's preferences, followed by a match-making process using cross-referenced user profiles and social compatibility metrics. The algorithm integrates diner feedback on restaurant experiences to suggest high-quality matches and suitable dining locations.

The feedback system is integral to the AI's learning process. After each date or dining experience, users are prompted to rate the experience in various categories such as food quality, service, and compatibility with the date. This feedback is anonymized and used to train the AI system, improving future recommendations. Negative experiences trigger a reassessment of restaurant and match suggestions, with the AI learning to avoid patterns that led to lower ratings.

Each module in the applications and methods operates through a series of well-defined processes. For example, the Date Scheduler module integrates with external restaurant reservation systems, allowing the app to pull real-time data on restaurant availability. The user's schedule and preferences are cross-referenced with the reservation data, and available slots are displayed in the app. Upon booking, the system confirms the reservation through a secure API connection with the restaurant's booking system.

The “Surprise Connection” feature works by using a randomization algorithm that selects compatible users and restaurants based on a weighted preference system. This algorithm takes into account both user profiles and dynamic restaurant data such as availability, ratings, and proximity. Once the matches are made, the system sends notifications to the users and allows them to accept or reject the suggestion.

Preferred embodiments of this invention introduce several new and novel concepts that revolutionize the dating and dining experience. By integrating dating and dining into a single platform, offering pre-payment options, personalized dining experiences, and other features that promote spontaneity, generosity, and safety, these embodiments address many of the limitations and pain points of traditional approaches. The comprehensive feedback system and icebreaker questions of these embodiments further enhance user interactions, making this invention a unique and innovative solution in the dating and dining market. This comprehensive approach to integrating dining and dating aims to foster respect, meaningful connections, and a unique, enjoyable user experience.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

This example is directed to DineMate, an app (including methods it implements) that is an embodiment of this invention that revolutionizes the dating and dining experience. With DineMate, users can effortlessly plan their dates, including selecting dates, times, and restaurants, all while pre-paying for their meals. This approach streamlines the dating process, making it more convenient and enjoyable. Personalization is at the core of DineMate. Users have the freedom to customize their meals, drinks, and desserts through their profiles, adding a unique and personal touch to their dining experiences. The app/method also eliminates the awkwardness of payment debates during dates, ensuring a seamless and pleasant atmosphere. But DineMate goes beyond just facilitating connections. The app/method is committed to creating a respectful environment by discouraging “Dine-and-Dash Daters” who exploit dates for free meals and preventing disruptive “Meal Escapers” who leave restaurants without settling their bills. In essence, DineMate is a go-to platform for authentic connections, personalized dining, and responsible engagement. It is a revolutionary app/method that combines convenience, customization, and a commitment to enhancing the dating journey, all while making the experience smoother and more enjoyable.

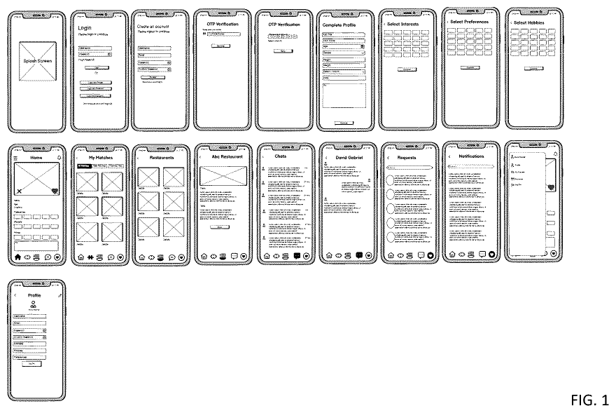

FIG. 1 shows a wireframe of some of the screens on a mobile device a user may see as examples. These include a splash screen with a logo, Login, Create an account, OTP Verification 1, OTP Verification 2, Complete Profile, Select Interests, Select Preferences, Select Hobbies, Restaurant, Abc Restaurant, Chats, David Gabriel Chat, Requests, Notifications, David Gabriel page, David Gabriel Profile.

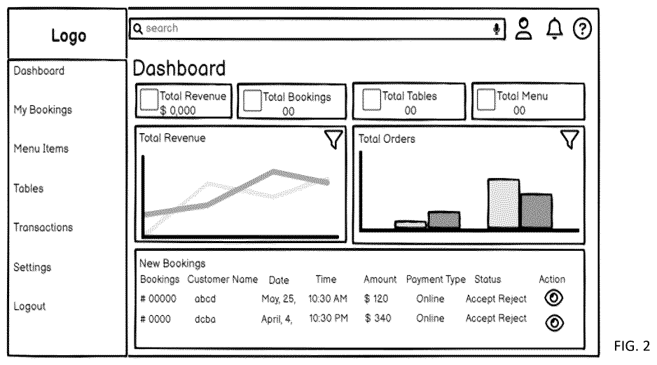

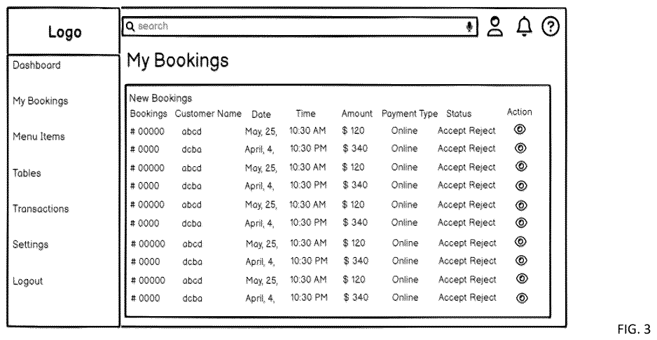

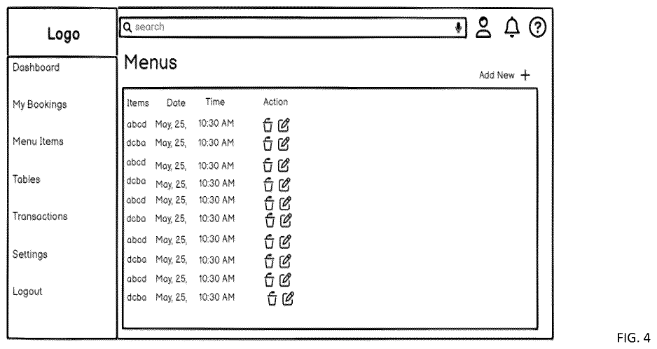

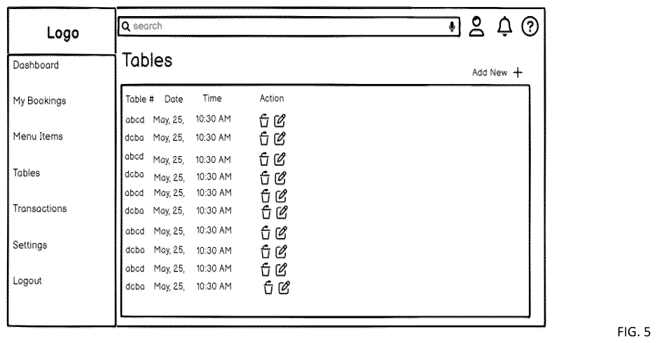

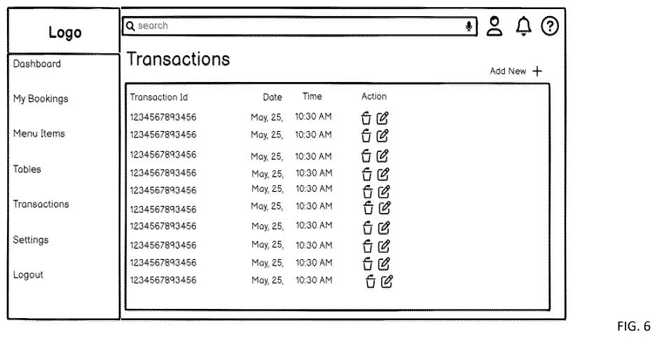

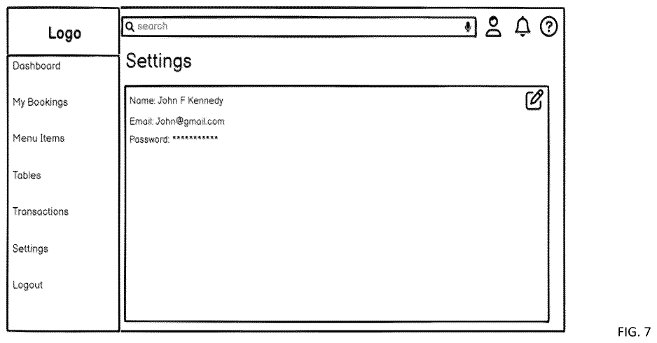

FIGS. 2-7 show examples of screen shot designs for various modules/features of an embodiment of this invention, including a Dashboard, My Bookings, Menu Items, Tables, Transactions, and Settings.

Tiers-Cake Level-refer to different subscription levels or membership plans that users can choose from based on their preferences and needs. Each tier provides a specific set of features and benefits. Here is a breakdown:

Cup Cake Access (Free): This tier provides access to basic profile features.
Cake Layer 1-Taste of DineMate ($4.99/month or $49.99/year): This introductory tier offers access to profile rating and feedback features.
Cake Layer 2-Savory Selection ($9.99/month or $99.99/year): Building on Tier 1, this tier includes all Tier 1 features plus the ability to upload a brief video called “Taste & Tell Clip”: (60 seconds or less) introducing yourself and sharing your preferred dining experiences.
Cake Layer 3-Fine Dining Elite ($19.99/month or $199.99/year): This premium tier includes all the features of Tier 1 and Tier 2, and adds the following:

Verification: Enjoy enhanced trust and safety with profile verification options.

Authenticity Checks: Feel confident in connecting with verified profiles, emphasizing profile authenticity.

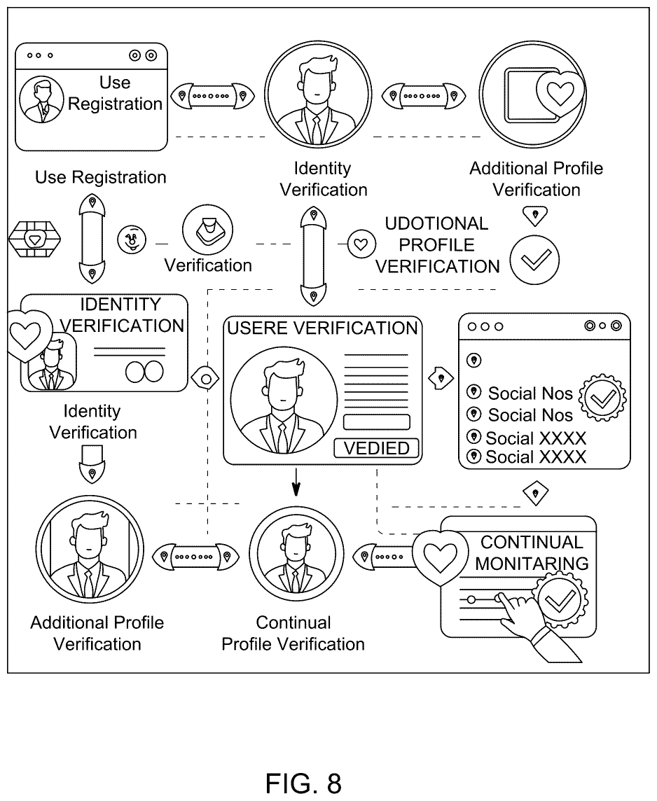

Flowcharts in FIGS. 8-12 show basic interactions for modules like Date Scheduler and Join My Table. These figures and flowcharts provide detailed visual representations of several key processes.

An AI-enhanced user matching embodiment shown in a flowchart (FIG. 8) illustrates how user data is collected, processed, and used to train an AI model embodiment. This flowchart should visualize how the AI module works, including the steps of data collection, training, and application. A breakdown of the flowchart elements includes:

### Step 1: User Profile Data Collection

Information such as preferences, past interactions, and feedback are collected.

### Step 2: AI Training Process

AI is trained using user profiles, diner feedback, and historical matching data.

Data points include dining preferences, compatibility feedback, and successful matches.

### Step 3: AI Application

AI suggests restaurants, matches users based on compatibility, and offers personalized experiences.

Recommendations are generated in real-time using the trained model.

### Step 4: Continuous Feedback Loop

After a dining experience or date, user feedback is collected and used to improve AI recommendations for future matches.

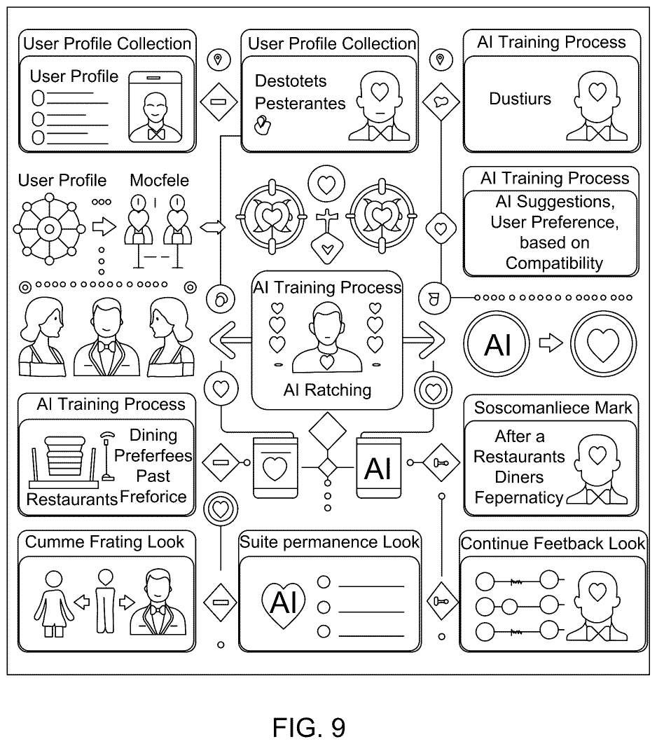

A profile verification embodiment is shown in a flowchart (FIG. 9), which outlines the steps involved in verifying a user's identity, from initial registration to ongoing monitoring. This flowchart can demonstrate how profile verification is completed and secured for trust and safety:

### Step 1: User Registration

User submits personal information (e.g., name, email, ID) and creates a profile.

### Step 2: Identity Verification

User's identity is verified through external verification services (e.g., third-party verification, government ID checks).

AI cross-checks user profile data against a trusted database.

### Step 3: Additional Profile Verification

Optional verification steps such as social media linking or manual verification.

### Step 4: Badge Assignment

Verified profiles receive a badge for other users to see.

### Step 5: Continuous Monitoring

Periodic checks and reviews are performed to maintain profile authenticity.

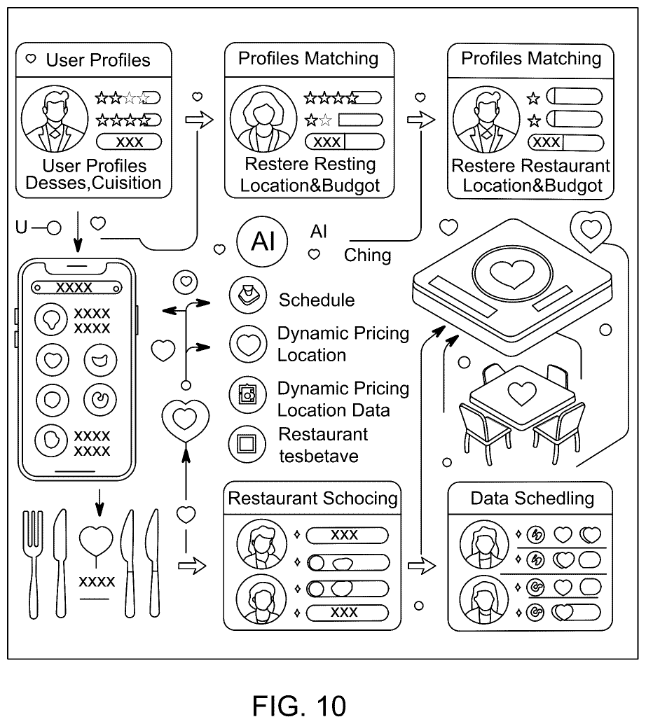

A restaurant and date matching embodiment is shown in a flowchart (FIG. 10), which outlines how the embodiment suggests dining locations and compatible matches based on dynamic user inputs and preferences. This flowchart can demonstrate how profile verification is completed and secured for trust and safety:

### Step 1: User Registration

User submits personal information (e.g., name, email, ID) and creates a profile.

### Step 2: Identity Verification

User's identity is verified through external verification services (e.g., third-party verification, government ID checks).

AI cross-checks user profile data against a trusted database.

### Step 3: Additional Profile Verification

Optional verification steps such as social media linking or manual verification.

### Step 4: Badge Assignment

Verified profiles receive a badge for other users to see.

### Step 5: Continuous Monitoring

Periodic checks and reviews are performed to maintain profile authenticity.

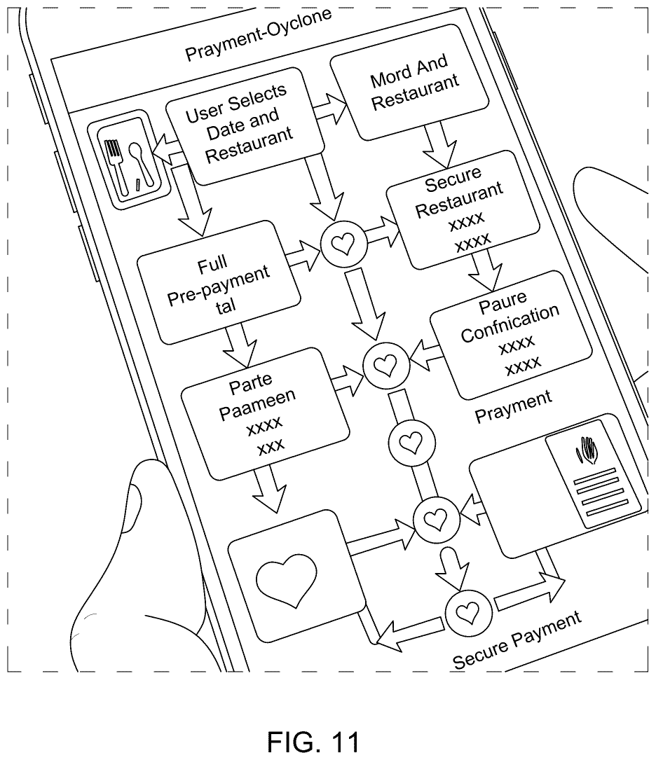

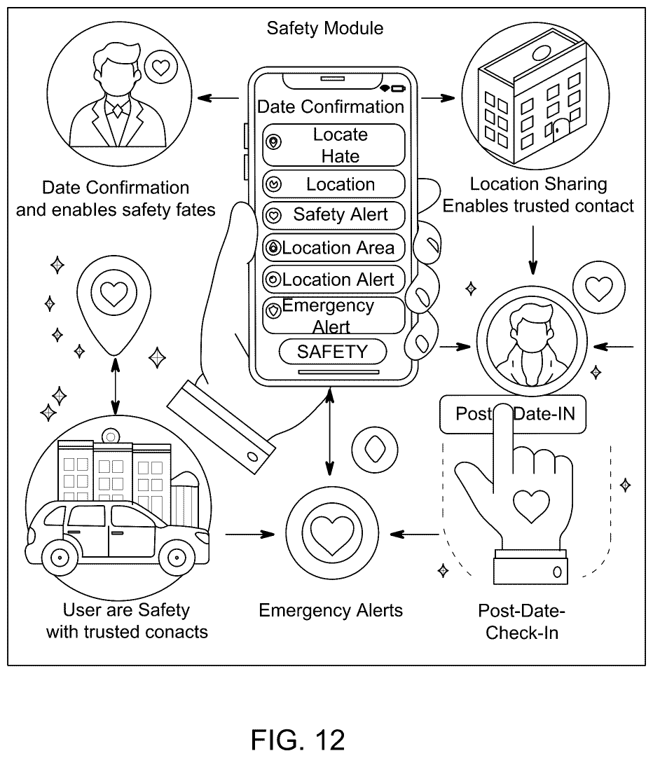

Additionally, a payment and pre-payment embodiment is shown in a flowchart (FIG. 11), which details a secure transaction process, and a safety module embodiment is shown in a flowchart (FIG. 12), which outlines safety features such as location sharing and emergency alerts.

Specifically, in FIG. 11 an integrated payment and pre-payment embodiment is shown, highlighting secure payment handling:

### Step 1: User Selects Date and Restaurant

User finalizes the date and confirms the reservation.

### Step 2: Payment Options

User chooses between full pre-payment, partial payment, or meal gifting.

### Step 3: Secure Payment

Payment is processed securely via an integrated gateway (e.g., PayPal, credit card).

### Step 4: Payment Confirmation

User receives confirmation of payment and reservation.

### Step 5: Pre-Payment Notifications

Restaurant receives a notification for the prepaid meal, and users are notified of any changes in status.

Specifically, in FIG. 12, the flowchart shows how this embodiment of an integrated payment and pre-payment process works, highlighting secure payment handling:

### Step 1: User Selects Date and Restaurant

User finalizes the date and confirms the reservation.

### Step 2: Payment Options

User chooses between full pre-payment, partial payment, or meal gifting.

### Step 3: Secure Payment

Payment is processed securely via an integrated gateway (e.g., PayPal, credit card).

### Step 4: Payment Confirmation

User receives confirmation of payment and reservation.

### Step 5: Pre-Payment Notifications

Restaurant receives a notification for the prepaid meal, and users are notified of any changes in status.

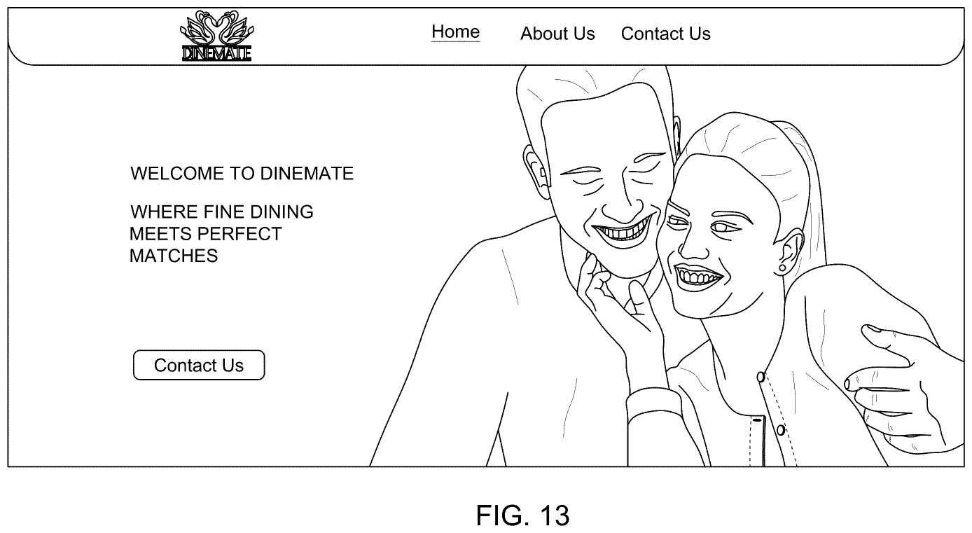

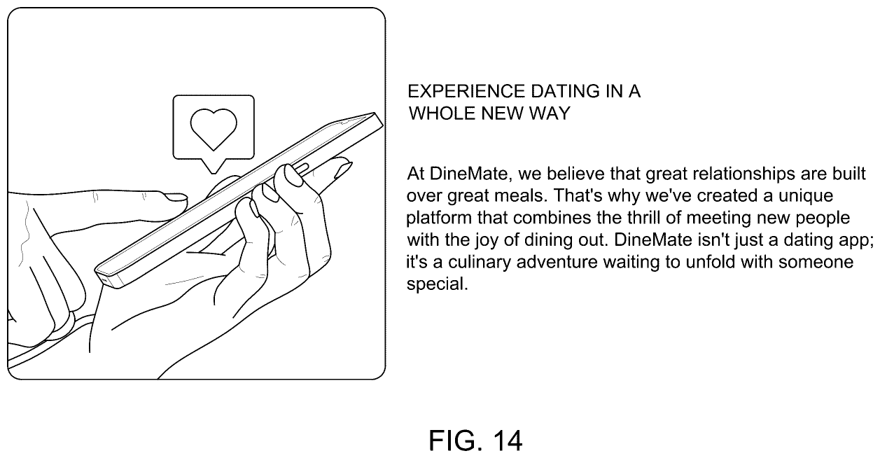

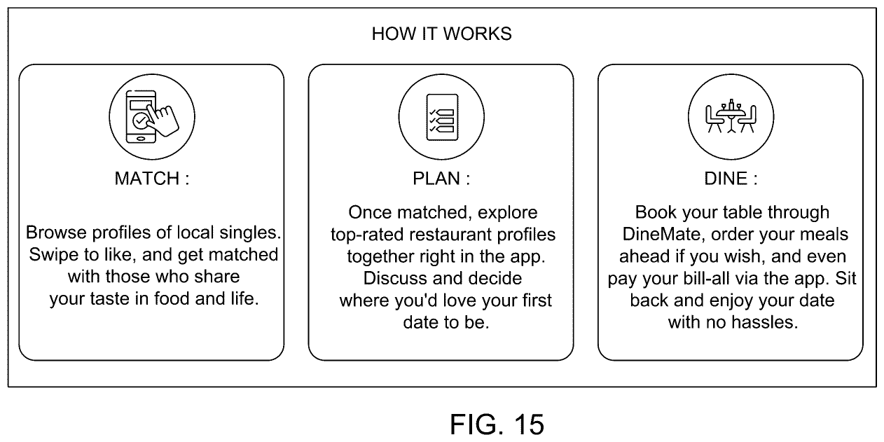

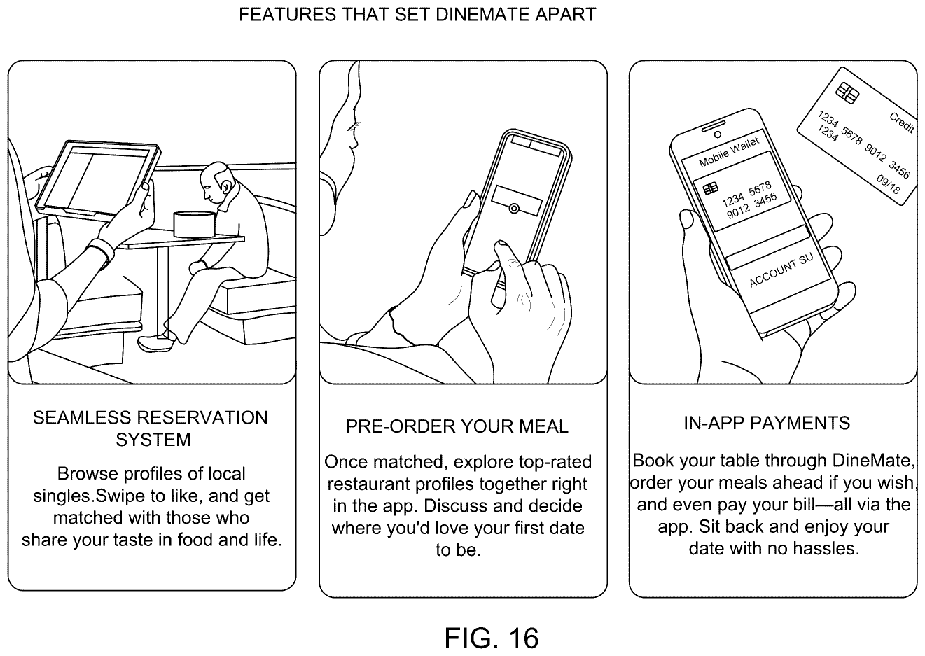

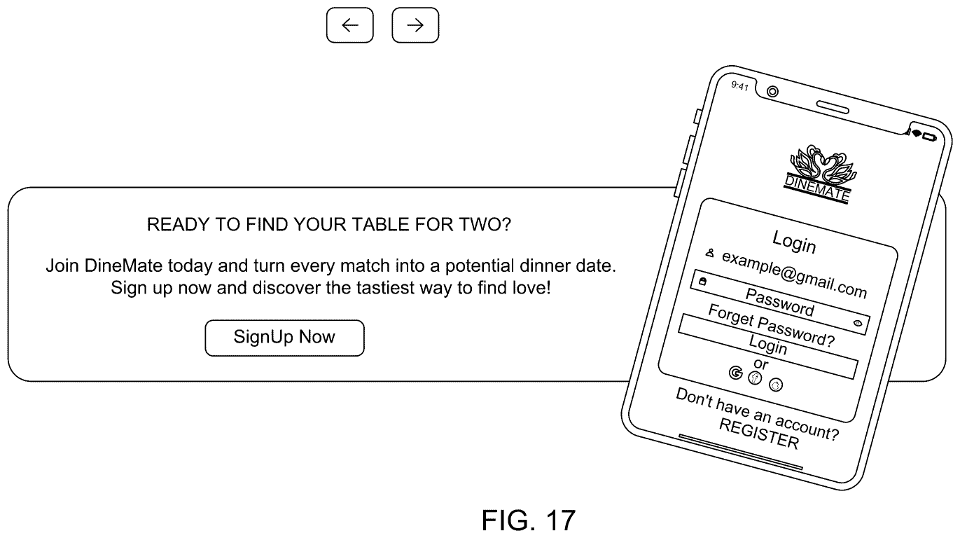

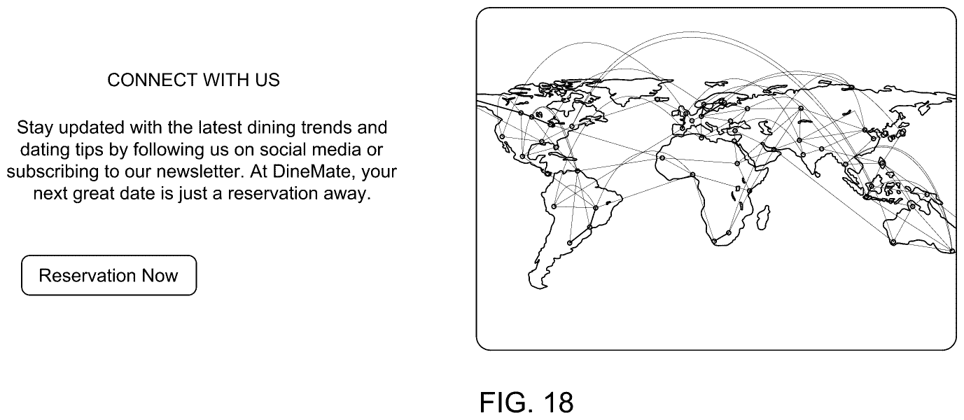

FIGS. 13-18 show examples of six screenshots of an embodiment of an application of this invention. FIG. 13 shows a first screen of the embodiment, DineMate. FIG. 14 shows some introductory information for this embodiment. FIG. 15 shows a brief road map of the application, with Match, Plan and Dine. FIG. 16 shows some of the features of the application, including seamless reservations, pre-ordering of meals, and in-app payments. FIG. shows a sign-up page and FIG. 18 shows a connection page in this example.

In applying this invention to a particular application, several steps can be taken. This includes Roadmap Refinement and Implementation:

### 1.1 Features:

Menu Mingle Assessment: Embark on a thrilling profile match assessment to guarantee a perfect compatibility match. The Menu Mingle Assessment tool ensures that you find someone who shares your interests, preferences, and lifestyle, enhancing the chances of a meaningful connection.

Partnered Restaurants: DineMate partners with a diverse range of restaurants, from casual dining spots to fine dining establishments, offering users a plethora of options to choose from. The curated selection ensures that there's something for every palate and occasion.

User-Friendly Interface: The user-friendly interface allows for seamless browsing and selection of restaurants based on various criteria such as cuisine type, price range, location, and dietary preferences.

Finding the perfect venue for your date has never been easier.

Detailed Information: Discover detailed information about each restaurant, including menus, reviews, and ratings, empowering users to make informed decisions when selecting a venue for their date. With DineMate, you can rest assured that your dining experience will be nothing short of exceptional.

Date Scheduler: This feature helps users find available reservations that align with their selected time and date, making the planning process easier and more efficient.

Join My Table: users can proactively schedule dates and invite others to join them at carefully selected restaurants, or they can be invited to join someone else's date. This feature encourages spontaneous connections and fosters shared dining experiences, making each date unique and memorable. Allowing users to pre-sign up for dates and have others join them at a selected restaurant adds a social and interactive aspect to the app. It can lead to spontaneous connections and shared dining experiences.

Surprise Connections: A random eating location feature adds excitement, encouraging users to explore new dining experiences. This feature becomes available after users find a match. They can choose the option for the app to randomly select a restaurant location based on their geographical area. Incorporating a random eating location feature can add an element of surprise and spontaneity to your app. This could be a fun way for users to try new places and experiences. Ensure that users have the option to filter or customize their preferences to some extent, such as specifying cuisine types or distance ranges, to make the experience enjoyable for all users. Expanding randomness to both restaurants and profiles generates dynamic and engaging interactions. This feature enables users to select an option in the app, and the app will match users based on others who have also chosen the same option. Expanding the random feature to both restaurants and profiles could make your app even more dynamic and engaging. Users could enjoy the excitement of discovering new dining locations and potential matches. This feature “Surprise Connections” highlighting the unexpected nature of the experiences it offers. Note: give users enough control to customize their preferences while still embracing the element of randomness and profiles must be verified.

Meal Gifter: A considerate feature lets users pay for their date's meal, promoting generosity and enhancing interactions. This option would be available both when users accept a date invitation and after the date ends. Allowing users, the option to pay for their date's meal is a thoughtful and considerate feature that can enhance the overall experience on your app. This will promote a sense of generosity and goodwill among users. This feature is called “Pay It Forward.” Note: ensure that the payment process is secure and user-friendly to avoid any complications.

Thankful Tidbit: A thoughtful addition lets users include gratuity when pre-paying for meals, recognizing restaurant staff. Also, for the higher tier member ship your gratitude automatically added to your dinner. Allow users to include a gratuity when pre-paying for their meals can simplify the payment process and ensure that restaurant staff are appropriately recognized. You could name this feature “Gratitude Tip” emphasizing the appreciation for the service provided. Note: Ensure that users have the option to select a gratuity amount or customize it based on their preferences.

### Ratings and Feedback

Diners Rating: Users provide feedback and accountability, aiding others in making informed decisions about potential dates. This will be based on 1-5 stars. Note other matches can see the diners rating. Implementing a date rating feature can be valuable for users to provide feedback and share their experiences. It adds a layer of accountability and helps others make informed decisions about potential dates. This feature is called “Rate Your Date”. Note: Make sure to design the rating system to be respectful and constructive, promoting healthy interactions within the app's community:

Star Ratings: Users can rate their dates on a scale of 1 to 5 stars, with 1 being the lowest and 5 being the highest.

Rating Categories: Users can provide ratings in specific categories, such as communication, punctuality, manners, and overall experience, on the same 1-5-star scale. Each category can be optional, allowing users to rate only the aspects they deem relevant.

Comment Section: Below the star ratings, there's a comment section where users can provide specific feedback and suggestions. They are encouraged to be respectful and constructive in their comments.

Taste Insights: A growth-oriented environment allows users to request constructive feedback on social and dating interactions. The constructive feedback option will be provided through pre-scripted responses, ensuring respectful communication that fosters a positive environment. Incorporating a feedback request feature can contribute to a positive and growth-oriented environment within the app. It provides an opportunity for users to receive constructive feedback and improve their social and dating interactions:

Anonymous Feedback: Users have the option to leave feedback anonymously, with a clear disclaimer about appropriate use and behavior. Anonymous feedback can be visible to the recipient but without the identity of the reviewer.

Response Mechanism: Both the reviewer and the recipient can respond to feedback. This encourages open communication and can lead to constructive discussions to resolve any issues.

Moderation: Feedback and comments go through a moderation process to filter out offensive or inappropriate content. Users are informed about the moderation process to maintain transparency.

Feedback Request: Users can send feedback requests to their past dates, and both parties have the option to accept or decline the request. Feedback requests are mutual, promoting fairness.

Private Feedback: Users can choose to keep their feedback private, visible only to the recipient. This ensures that sensitive feedback remains confidential.

Feedback History: Users have access to their feedback history, which includes all past ratings, comments, and responses. This allows them to track their progress and see areas for improvement.

Rating Averages: Each user's profile displays an average rating based on all received feedback. This provides a quick overview of their dating experiences.

Educational Resources: Within the feedback section, users can access educational resources and tips on giving and receiving feedback effectively. This helps them understand the importance of feedback for personal growth.

This comprehensive feedback rating system combines star ratings with detailed categories, comments, and features that promote respectful and constructive interactions within your app's community. It empowers users to provide and receive feedback effectively, enhancing the overall dating experience.

Allergy Alert: Prioritizing safety, users can specify allergies in profiles, ensuring enjoyable and secure dining experiences. Users can select this option during their profile creation process. Allow users to specify their allergies in their profiles can help ensure that dining experiences are enjoyable and safe. This feature is called “Allergy Alert” conveying the importance of being mindful of dietary restrictions. Note: Make sure users can easily input and update their allergy information, and that potential matches can view these details when planning a date.

Verified Profiles: Enhancing trust and safety, verified profiles give users confidence through authenticity checks. Note background check Optional Graded verification example. Incorporating a profile verification option can enhance trust and safety within your app's community. Users can feel more confident interacting with verified profiles. You could name this feature “Certified Profiles” emphasizing the reliability of the profiles. Implement a straightforward verification process, possibly involving phone numbers, social media accounts, or photo verification, to ensure authenticity while maintaining user privacy.

Icebreaker Questions Feature Description:

After a date is confirmed, users have the option to receive icebreaker questions based on their profiles.

These questions are designed to spark interesting and meaningful conversations during the date.

### Implementation Steps:

### User Preferences:

Allow users to set their preferences for receiving icebreaker questions. They can choose to:
Receive icebreaker questions automatically after confirming a date.
Opt-out of receiving icebreaker questions.
Include a reminder option to notify users about the icebreaker questions before the date.

### Question Categories:

Create different categories of icebreaker questions to cater to various interests and conversation styles. For example:
Food-related questions: “What's your favorite cuisine?”
Travel questions: “Share a memorable travel experience.”
Hobbies and interests: “What do you enjoy doing in your free time?”

### Profile-Based Questions:

Use the information from users' profiles to generate personalized icebreaker questions. For instance:
If a user mentions a love for Italian cuisine, an icebreaker question could be, “Have you ever tried making homemade pasta?”
If a user lists hiking as an interest, a question could be, “What's the most breathtaking hike you've been on?”

### Random Questions:

Include an option for users who prefer spontaneity to receive random icebreaker questions unrelated to their profiles. This can add an element of surprise to the conversation.

### User Approval:

Allow users to review and approve the generated icebreaker questions before they are sent to their date. This gives users control over the conversation topics.

### Icebreaker Library:

Maintain a library of icebreaker questions that users can browse and select from if they prefer to choose their own questions.

### In-App Messaging:

Implement an in-app messaging feature that allows users to exchange icebreaker questions and responses with their date.

### Feedback Loop:

Encourage users to provide feedback on the effectiveness of the icebreaker questions in starting conversations. Use this feedback to refine and improve the feature.

### Privacy and Safety:

Ensure that the icebreaker questions are respectful and do not violate privacy boundaries.

Implement reporting and blocking features in case of misuse.

### User Assistance:

Offer tips or guidance on how to use icebreaker questions effectively to initiate engaging conversations.

By integrating this icebreaker questions feature, you can enhance the overall user experience by reducing initial awkwardness and encouraging meaningful interactions between users on their dates.

### 1.2 Target Audience:

Busy Professionals: Those with busy schedules who want to streamline the dating process and make the most of their limited free time.

Food Enthusiasts: Individuals who are passionate about trying new restaurants and culinary experiences and want to share this interest with potential partners.

Safety-Conscious Daters: People who prioritize safety and appreciate the option to specify allergies, pre-pay for meals, and engage in a respectful community.

Adventurous Singles: Those looking for spontaneous and exciting dating experiences, such as trying new restaurants or meeting new people in a unique way.

Young Professionals: Millennials and Gen Z individuals who are open to innovative dating approaches and value experiences over traditional dating norms.

Travelers: People who travel frequently and want to connect with locals or other travelers over shared meals in various locations.

Tech-Savvy Users: Those comfortable with using mobile apps to enhance their social and dating interactions.

### 1.3 Unique Selling Points (USPs)

Pre-Planned Pairings: Discover spontaneity through pre-planned dates. Join others for an exciting dining experience at selected restaurants, fostering connections in an unexpected way.

Customized Culinary Experience: Personalize your meals, drinks, and desserts through your profile, ensuring that each dining experience reflects your tastes and preferences.

Awkwardness-Free Dining: Eliminate the awkwardness of deciding who pays for the meal. With prepayment, enjoy your date without any financial pressures.

Respectful Community: Embrace a community that discourages “Dine-and-Dash Daters” and promotes meaningful connections, ensuring a respectful and genuine environment.

Safety and Allergen Awareness: Specify allergies in profiles for secure and enjoyable dining. Safety is a priority, offering peace of mind with every meal.

Random Adventure: Spice up your dining journey with the “Adventurous Eats” feature. Discover new restaurants and flavors, embracing the unexpected.

Meaningful Feedback Exchange: Seek and provide constructive feedback on social and dating interactions, fostering growth and authenticity in your connections.

Generosity Made Easy: Express thoughtfulness through the “Meal Gifter” feature, allowing you to pay for your date's meal and enhance your interactions.

Verified Profiles: Connect confidently with verified profiles, ensuring the authenticity of your potential matches and creating a secure dating atmosphere.

Effortless Connections: Engage in “Surprise Connections” where shared preferences bring users together, opening doors to exciting and engaging interactions.

Elevated Dining Experience: Elevate your dates beyond mere meals. DineMate combines culinary exploration and meaningful connections for unforgettable experiences.

Market Research: The landscape of online dating in the United States has evolved significantly, transforming the way individuals form connections with potential partners. Recent insights from the Pew Research Center provide valuable perspectives on Americans' experiences and attitudes towards online dating. Here is a summary of some key findings:

Approximately 30% of U.S. adults have engaged with dating apps or websites, with 9% doing so in the past year.

Young adults under 30 are more inclined towards online dating, with 53% having used such platforms compared to 13% of those aged 65 and above.

Online dating is more prevalent among Lesbian, Gay, and Bisexual (LGB) adults (51%) compared to heterosexual adults (28%).

Men (34%) show greater interest in online dating than women (27%), and individuals with some college education exhibit higher usage.

Never-married individuals (52%), those living with partners (46%), and divorced/widowed/separated individuals (36%) are more likely to use online dating than married individuals (16%).

Online dating platform usage is consistent across White, Black, Hispanic, and Asian adults.

Tinder leads as the most popular dating app (46%), especially among those under 30. Noteworthy platforms include Match (31%) and Bumble (28%).

Tinder is favored by younger users (79% of those under 30), while Match is preferred by older users (50%).

One in ten partnered adults met their current partner through a dating app or site, with higher rates among LGB individuals (24%).

User experiences with online dating vary, but slightly more report positive experiences (53%) compared to negative ones (46%).

Positive experiences are more common among men (57%) than women (48%), and LGB users (61%) report more positive experiences than heterosexual users (53%).

Roughly one-third of online daters (35%) have paid for premium features, with higher income and older users more likely to do so.

Users who have paid for online dating tend to report more positive experiences (58%).

Both genders face challenges, with women feeling overwhelmed by message volume and men feeling insecure about receiving fewer messages.

Unwanted behaviors on dating platforms are common, including explicit messages/images, unwanted contact, offensive names, and threats of harm.

About half (52%) of online daters believe they have encountered scammers, with men under 50 more likely to have experienced this (63%).

### Financial Aspects

The financial aspects of using dating apps involving over 5,000 paid subscribers of popular dating apps. Here are the main points:

Average Annual Spending: Studies reveals that paid subscribers to dating services spend approximately $58 per year on average. This expenditure is associated with users who opt for premium, paid versions of dating apps rather than free services.

Income Influence: Interestingly, the more money users make, the more they tend to spend on dating apps, with a few exceptions in the highest income bracket.

Credit Score Impact: Users with better credit scores also tend to spend more on dating apps, except for those with “excellent” credit.

Cuffing Season Myth: The concept of “cuffing season,” where people seek romantic partners during colder months, is debunked by the data. Studies suggests that the search for a partner, as reflected in paid dating app subscriptions, remains relatively consistent throughout the year, with small spikes in July and December.

Regional Spending: The top 10 states with the highest average annual spending on dating services. Virginia leads the list with an average of $143 per month, followed by Pennsylvania, New Jersey, Massachusetts, Maryland, Colorado, Georgia, Illinois, Arizona, and North Carolina.

Age and Spending: The study finds that individuals of various age groups, from 18 to over 65, are looking for love through dating apps. On average, 18 to 24-year-olds spend about $50 per year, while daters over 65 spend nearly double, approximately $99 per year.

The financial aspects of using dating apps, including the variation in spending based on income, credit score, and location, as well as the consistency of dating app usage throughout the year.

The average annual spending of approximately $58 per year, you may want to price your tiers competitively while offering appealing features to justify the cost.

How DineMate Will Compare to the market:

Here is how DineMate's offerings align with the provided statistics:

Growing Market: The fact that around 30% of U.S. adults have used dating apps or sites indicates a substantial market for online dating platforms. DineMate's innovative approach to combining dining experiences with connections could attract users looking for something different.

Targeting Young Adults: DineMate's features cater to younger adults, who are more likely to use online dating platforms. The app's focus on personalized dining experiences and spontaneous connections aligns well with the preferences of this demographic.

Inclusivity: DineMate's appeal to individuals of all races and sexual orientations matches the diverse usage of online dating platforms across different demographic groups.

Preference for Different Apps: The popularity of Tinder, Match, and Bumble shows that users are open to exploring various apps. DineMate's unique focus on combining dining and connections could attract users seeking more meaningful interactions.

Positive Experiences and Feedback: The statistics reveal that slightly more people report positive experiences with online dating. DineMate's emphasis on feedback, verification, and a safe community aligns with users' desire for positive interactions.

Paying for Premium Features: The willingness of users to pay for premium features suggests that DineMate's options for pre-paying, gifting meals, and other value-added features could resonate with users.

Challenges and Concerns: The challenges and concerns faced by online daters, such as encountering scammers and unwanted behaviors, present an opportunity for DineMate to emphasize its safety features, verification process, and respectful community.

Taste Check Verification Grading:
Unsatisfactory Check (Grade 1)—“Bland”: This indicates a background check that has not met the minimum requirements and lacks depth, like bland, unexciting food.
Basic Check (Grade 2)—“Average”: This represents a standard background check that meets basic criteria but doesn't stand out, like average or everyday food.
Satisfactory Check (Grade 3)—“Tasty”: A background check at this level is deemed satisfactory and provides a decent assessment, akin to tasty, enjoyable food.
Good Check (Grade 4)—“Flavorful”: This suggests a background check that goes beyond the basics, offering more insight and depth, much like flavorful and well-prepared dishes.
Excellent Check (Grade 5)—“Delicious”: An excellent background check provides comprehensive information and is highly reliable, like delicious, top-tier cuisine.
Outstanding Check (Grade 6)—“Exquisite: This represents the highest level of background check excellence, characterized by thoroughness and accuracy, comparable to exquisite, gourmet dining experiences.

Example of a Profile Questionnaire for this embodiment:
Name and Profile Picture: (A) [Enter Name]
Age: (A) [Enter Age]
Race: (A) [Enter Race/Ethnicity]
Height: (A) [Enter Height]
Weight: (A) [Enter Weight]
Allergies: (A) [Enter Allergies, if any]
Introvert or Extravert: (A) Introvert (B) Extravert
Location: (A) [Enter Location]
Gender preference: (A) Heterosexual (B) Homosexual (C) Bisexual (D) Other
Looking for: (A) Male (B) Female (C) Open to All
What's your idea of a perfect date night? (A) Exploring new restaurants and flavors (B) Enjoying a cozy dinner at a favorite spot (C) Coffea Date: Note This combines “coffee” and “tea”
How do you feel about personalized dining experiences? (A) Love the idea of customizing my meals, drinks, and desserts (B) Prefer sticking to the regular menu
When it comes to paying for meals on a date, which option appeals to you? (A) Pre-paying for a seamless and stress-free experience (B) Deciding who pays in the moment
Which kind of connections do you value most in a dating app community? (A) Meaningful and respectful interactions (B) A mix of casual and serious interactions.
Are you open to trying new dining experiences on a whim? (A) Absolutely, I enjoy the element of surprise (B) I prefer planning my dining experiences in advance
How important is receiving and providing constructive feedback in a dating community? (A) Very important, I believe in personal growth through feedback (B) Not a priority, I prefer a more spontaneous approach
Do you consider safety and allergies when dining out? (A) Yes, it is essential to ensure enjoyable dining experiences (B) Not a major concern for me
Are you open to paying for your date's meal as a gesture of generosity? (A) Yes, I think it is a thoughtful way to enhance connections (B) I prefer sharing expenses equally
How do you feel about verified profiles for added authenticity? (A) I appreciate the confidence of connecting with verified users (B) It does not matter much to me
Are you intrigued by the idea of spontaneously connecting with others who share your preferences? (A) Yes, it sounds exciting and fun (B) I prefer more structured connections.

### Example 2

This example is directed to the implementation of the features for a particular embodiment of this invention.

Wireframing and Design: Create a rough sketch or wireframe of your app's user interface. Design the app's layout, user flow, and visual elements.

Technical Planning: Decide on the technology stack for your app (programming languages, frameworks, etc.).

Backend Development: Develop the server-side logic that will handle user profiles, restaurant data, meal selections, payments, and other functionalities. A backend-as-a-service (BaaS) solution can be considered for faster development.

Frontend Development: Build the user interface and user experience of the app. Focus on making it intuitive and user-friendly. Test the app on different devices to ensure responsiveness.

Integration: Integrate payment gateways for seamless transactions. Also, integrate features like real-time notifications, GPS for location-based features, and any other functionalities specific to your app.

Testing: Thoroughly test your app to identify and fix any bugs, glitches, or user experience issues. Consider beta testing with a small group of users to gather feedback.

Launch: Once you are confident in the app's functionality and design, launch it on the app stores (Apple App Store and Google Play Store). Prepare compelling app descriptions and visuals for the store listings.

Marketing and Promotion: Develop a marketing strategy to promote your app. Utilize social media, content marketing, influencer partnerships, and other channels to reach your target audience.

Gather Feedback: Pay attention to user feedback and reviews after the launch. Continuously improve your app based on user suggestions and needs.

Updates and Maintenance: Regularly update your app with new features, improvements, and bug fixes to keep users engaged and satisfied.

### Example 3

This example addresses the integration of restaurant payments into apps of this invention. To integrate restaurant payments into your app services you will need to implement a robust payment gateway and partner with restaurants to enable online ordering and payment processing. Here are the key steps and technologies involved:

Payment Gateway: Integrate a secure payment gateway like Stripe, PayPal, or a custom payment solution to handle transactions between users and restaurants. This gateway ensures safe and reliable payment processing.

Restaurant Partnerships: Collaborate with restaurants to onboard them onto your platform. Restaurants should have the capability to accept orders and payments through your app.

Menu Integration: Develop a system for restaurants to upload their menus, including items, descriptions, prices, and available options.

Order Placement: Implement features for users to browse restaurant menus, select items, customize orders, and place orders through the app.

Payment Processing: Integrate a secure payment flow where users can enter their payment details, including credit card information, and complete the transaction. Ensure compliance with payment industry standards for security.

Order Confirmation: Provide users with order confirmation details, including the total amount paid, estimated delivery or pickup time, and order summary.

Real-Time Updates: Enable real-time order tracking and updates so users can monitor the status of their orders and receive notifications when the order is ready.

Delivery or Pickup Options: Allow users to choose between delivery and pickup options, specifying their preferences and location.

Ratings and Reviews: Implement a rating and review system where users can provide feedback on restaurants, delivery services, and the quality of their meals.

Customer Support: Offer customer support channels for users to address any issues related to orders, payments, or restaurant experiences.

Data Security: Ensure robust data security measures to protect users' personal and payment information.

Legal Compliance: Comply with relevant laws and regulations, including data protection, online payment processing, and food safety standards.

Partnering with restaurants for your app involves several steps to ensure a successful collaboration. These can include:

Research and Identify Potential Partners: Identify restaurants that align with your app's target audience and concept. Consider factors such as cuisine type, location, popularity, and reputation.

Value Proposition: Clearly communicate the value proposition of partnering with your app to restaurants. Highlight how the app can drive additional foot traffic, increase visibility, and attract new customers to their establishment.

Offer Benefits: Offer attractive benefits to restaurants for partnering with your app, such as increased exposure through app promotion, access to a broader customer base, and potential revenue growth.

Negotiate Terms: Negotiate mutually beneficial terms with the restaurants, including commission rates or fees for orders placed through the app, promotional opportunities, and any other terms of the partnership agreement.

Provide Support and Training: Offer support and training to restaurants on how to effectively use the app, manage orders, update menus, and handle customer inquiries or issues.

Integration and Onboarding: Assist restaurants with integrating their menus, photos, and other relevant information into the app. Ensure a smooth onboarding process to minimize any friction and ensure a positive experience for both the restaurant and app users.

Maintain Communication: Maintain open communication channels with partnered restaurants to address any concerns, provide updates on app performance, and gather feedback for continuous improvement.

Promotion and Marketing: Promote partnered restaurants through the app, social media, email newsletters, and other marketing channels to drive awareness and encourage app users to dine at these establishments.

### Example 4

In certain of the most preferred embodiments, applications and methods for facilitating a dating experience for a user using a mobile device are provided. These applications comprise several modules that can be provided in different combinations or separately. These embodiments specifically comprise: (a) a memory access module to store and retrieve dining and dating information, the dining and dating information comprising the user's schedule, preferences, and personal information, the dining and dating information stored in memory on a storage medium; (b) a questionnaire module that presents questions to the user on an interface concerning the user's schedule, preferences, and personal information, and stores the user's schedule, preferences, and personal information on the storage medium in a user's profile using the memory access module; and (c) a first set of multiple modules that integrate the dining and dating information and the user's profile.

This first set of modules can be provided with some or all of them combined together or separately. They can comprise some or all of the following: i. a personalized dining module that matches the user's profile to meals, drinks, and desserts at a restaurant; ii. a date scheduler module that identifies available reservations at the restaurant based on the user's profile; iii. a Join My Table module that identifies other users to join the user at the restaurant; iv. a Surprise Connection module that randomly selects restaurants based on the user's profile; v. a Meal Gifter module that allows the user to pay for the meal of another user; vi. a Thankful Tidbit module that allows the user to pre-pay for meals at the restaurant; vii. a diners rating and feedback module that allows the user to provide feedback concerning the restaurant, other users, and the dating experience; viii. an allergy alert module that identifies potential allergy risks to the user based on the user's profile; and ix. a verification module that verifies the accuracy of the user's profile, including but not limited to identity data for trust and safety.

These applications and methods in some embodiments have an additional set of modules in addition to the first set of modules described in the paragraph above. This second set of one or more modules further integrates the dining and dating information and the user's profile, and this second set of modules can comprise one or more of: i. a pre-order flowers/candy module that pre-orders flowers and candy for the dating experience; ii. a hair and beauty services module that pre-books hair and beauty services for the dating experience; iii. a car wash services module that pre-orders car wash services for the dating experience; iv. a coffee or tea date module that sets up casual coffee or tea for the dating experience; v. a profile matching algorithm module that uses the user's profile to match the user with other compatible users; vi. a dynamic pricing and offers module that identifies dynamic pricing, discounts, and special offers from restaurants or relevant to the dating experience; vii. an event integration module that identifies local events or themed experiences for the dating experience; viii. a virtual dining module that provides the option to select virtual dining experiences; ix. a subscription tiers and loyalty program module that allows the user to select which modules to apply based on a subscription level; x. an AI module that uses AI-driven recommendations for restaurants and dating matches, where the AI is trained using the user's profile, other users' profiles, and data from the diners rating and feedback module; xi. an integrated payment module that secures payments for the restaurant and other services; xii. a safety module that includes location sharing, emergency alert buttons, and post-date check-ins for enhanced user safety; xiii. an in-app messaging and video calls module that enables secure private messaging and video calls between users; xiv. an app feedback and reporting module that allows users to report inappropriate behavior, app bugs, and provide feedback; and xv. a cross-user rating and feedback module that allows users to access ratings and feedback concerning other users and dining experiences from the diners rating and feedback module.

### Example 5

A system of components (and the methods they implement) applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

1. An application for facilitating a dating experience for a user using a mobile device, the application comprising:
a. a processor and a memory storing instructions that, when executed by the processor, cause the application to store and retrieve dining and dating information comprising a user schedule, preferences, and personal information in a user profile maintained in the memory;
b. present, via a user interface, a questionnaire to the user and store responses to the questionnaire in the user profile;
c. process the user profile to generate dining and dating outputs by executing a set of coordinated operations comprising:
i. matching the user profile to restaurant menu data to identify dining options;
ii. querying reservation data from one or more external reservation systems to identify available reservations corresponding to the user profile;
iii. identifying one or more other users based on compatibility metrics derived from stored user profiles;
iv. generating one or more restaurant selections based on the user profile and available reservation data;
v. processing a payment transaction associated with a selected dining event, including at least one of pre-payment or payment on behalf of another user;
vi. processing gratuity or pre-payment components associated with the dining event;
vii. storing feedback data associated with at least one of the dining event or interaction with another user;
viii. identifying dietary constraints or allergy risks based on the user profile;
ix. verifying at least a portion of the user profile using one or more external data sources; wherein the dining and dating outputs are dynamically updated based on user interaction and stored feedback data.

2. The application of claim 1 wherein the verification module further comprises one or more of the following additional capabilities:
periodic re-verification, monitoring user activity patterns, cross-referencing with third-party databases, incorporating user feedback, or validating linked social media data.

3. The application of claim 1 further comprising:
d. additional coordinated operations comprising:
i. generating pre-orders for goods associated with the dining event;
ii. generating pre-orders for personal services associated with the dining event;
iii. generating service-related scheduling operations associated with the dining event;
iv. generating alternative dining event options;
v. generating compatibility matches using a profile-based matching algorithm;
vi. identifying ddynamic pricing, discounts, and promotional offers;
vii. identifying event-based experiences associated with the dining event;
viii. generating virtual dining options;
ix. processing subscription-based feature selection;
x. generating recommendations using a trained machine learning model based on user profiles, feedback data, and historical interaction data;
xi. processing secure payment transactions;
xii. providing safety features including location sharing, alert generation, or post-event verification;
xiii. enabling secure messaging or video communication between users;
xiv. receiving reports associated with user interactions or application performance;
xv. providing access to ratings and feedback associated with users or dining experiences.

4. The application of claim 1, wherein
the dining and dating information, the user profile, and associated data are at least one of anonymized, aggregated, encrypted, audited, or processed in compliance with data privacy regulations.

5. A method for facilitating a dating experience for a user using a mobile device comprising:
storing and retrieving dining and dating information comprising a user schedule and preferences in a user profile stored in memory accessible to the mobile device;
presenting a questionnaire to the user via a user interface and storing responses in the user profile;
processing the user profile to generate dining and dating outputs by performing coordinated operations comprising the operations recited in claim 1;
wherein the outputs are dynamically updated based on user interaction and stored feedback data.

6. The method of claim 5, wherein verification comprises periodic re-verification, monitoring behavior patterns, cross-referencing external databases, incorporating feedback data, or validating social media data.

7. The method of claim 5 further comprising
performing the additional coordinated operations recited in claim 3.

8. The method of claim 5, wherein the dining and dating information and user profile data are at least one of anonymized, aggregated, encrypted, audited, or processed in compliance with applicable data privacy laws.
